(19) United States
(12) Patent Application Publication
(10) Pub. No.: US 2024/0031175 A1
(43) Pub. Date: Jan. 25, 2024

(54) SINGLE-PURPOSE CERTIFICATES WITH HASH VALUES TIED TO SPECIFIC ARTIFACTS OR CONNECTIONS RELATED APPLICATIONS

(71) Applicant: SCRIBE SECURITY LTD., Tel Aviv-Yafo (IL)

(72) Inventor: Daniel NEBENZAHL, Ariel (IL)

(21) Appl. No.: 18/222,687

(22) Filed: Jul. 17, 2023

(30) Foreign Application Priority Data
Jul. 19, 2022 (IL) 294869

(51) Int. Cl. H04L 9/32

(52) U.S. Cl. CPC H04L 9/3268; H04L 9/3236

(57) ABSTRACT

A method of securing defined artifacts, or secure connections, includes: generating a single-purpose public key and private key combination; creating a set of hashes of unique information characterizing one or more specific connections or artifacts; sending the single-purpose public key and the set of hashes to a certificate authority; receiving from the certificate authority a single-purpose certificate that includes fields storing an identity of a signer, the set of hashes, metadata identifying the hashed unique information, and the single-purpose public key, wherein the single-purpose certificate is signed with a certificate authority private key; publishing or sending the single-purpose certificate to a verifier, and, with the single-purpose certificate, at least one of establishing one or more secure connections with the verifier or sending the one or more artifacts to the verifier. A method of signature revocation includes, following signing an artifact with the private key, revoking the certificate.

### CROSS-REFERENCE

This application claims the benefit of priority of Israeli Patent Application No. 294,869, filed Jul. 19, 2022, entitled “Single-Purpose Certificates with Hash Values Tied to Specific Artifacts or Connections,” the contents of which are incorporated by reference as if fully set forth herein.

### FIELD OF THE INVENTION

The present Application relates to the field of cybersecurity, and more specifically, but not exclusively, to single-purpose certificates including therein hash values related to one or more specific artifacts or one or more specific secure connections.

### BACKGROUND OF THE INVENTION

Public key cryptography, with private key/public key pairs verified by certificates, has become a standard tool for enabling secure transmission of artifacts or for effecting secure transmissions. Most public-key cryptography solutions use a trusted third party, known as a certificate authority, to attest to the identity of the private key owner—namely, to attest that the holder of the private key is a specific person or a specific machine. This attestation is given as a certificate. The most widely-used certificate format complies with the X.509 standard, and includes various fields defining how to document information such as identity, usage, and expiration time. A Public key infrastructure (PKI) is a set of hardware, software, policies, processes, and procedures required to create, manage, distribute, use, store, and revoke digital certificates and public-keys.

As a default, private and public key pairs are multi-use, meaning that the same keys are used for authenticating multiple transmissions. Multiple uses of the same key pair is, on a basic level, efficient. However, the extended use of key pairs also results in various costs and risks.

First, private-key holders need to protect their private keys and detect their compromise. If a user suspects that a private key has been compromised, the user may wish to revoke the private key. Likewise, users may generate new private keys on a regular basis, in order to decrease the advantage that may be obtained by a malicious actor that had managed to compromise a private key without being detected. Thus, in order for a verifier to be confident that a private key has not been revoked or expired, each PKI must include certificate revocation services and certificate revocation lists, which allow revocation of keys in case a private key was exposed or compromised. Simultaneously, public key holders need to track these revocation lists in order to follow private-key compromises or renewals.

In addition, classic private key/public key pairs do not offer a ready solution for revocation of signatures, while maintaining continued use of the private key/public key pair. Typically, in order to revoke a signature, it is necessary to utilize a signature revocation service.

Short-lived keys obviate many of the costs associated with maintenance of keys. Short-lived keys are preprogrammed to expire after a certain time. After the expiration of the keys, the private keys are deleted. This short time frame poses a challenge to the attacker and thus lowers the need to protect the private keys. In addition, due to the low chances of key compromise during the lifetime of the key, the need for revocation services and handling is also lower.

However, implementing a short-lived key requires additional infrastructure of its own. In particular, in order to ensure that the private keys are not used outside of the time frame designated time frame, it is necessary for the PKI to include a timestamping service. For example, when the private key user signs an artifact, the private key user obtains a timestamp for that signature from a trusted entity. The timestamp enables the public key user to verify that the signature was created within the allowed time frame. In some cases, the timestamping is done by a transparency log service accessible to public key users.

The use of timestamps introduces its own set of challenges. The signing and verification process necessarily becomes a multi-step process, including requesting a short-lived certificate from a certificate authority, uploading a signature to a timestamping service, and verifying that the signature is timestamped. The reliance on timestamps is also complex from the perspective of the recipient. In particular, each verification requires verification of not only the certificate itself, but also of the timestamp. This, in turn, may require that time data be available to the verifier. In many settings, however, such as in low-power devices, such time data is not available. Second, verification of a signature requires access to the timestamp. If the timestamp is stored at an external service such as a transparency log, the verifier must access the transparency log via an online connection, which is sometimes undesirable due to communication latency or security concerns.

### SUMMARY OF THE INVENTION

The present disclosure introduces a method for using single-purpose certificates. The single-purpose certificates are coded with information that is specific to one or more particular artifacts or one or more specific secure connections. In particular, the single purpose certificates store therein, as part of the certificate, a hash value (or hash values) of unique information associated with the artifact(s) or connection(s). The recipient may apply the hash function to the unique information, and compare the resulting hash value with the hash value stored in the certificate.

Use of a single-purpose certificate including a hash value of the unique information provides significant benefits over known alternatives. First, the single-purpose certificate may be verified without the use of timestamps, and thus saves the need for a timestamping service. A timestamp is usually not necessary because, in any case, the certificate will be rejected if it is used for transmission of an artifact or for a connection for which it was not initially intended. In addition, use of the hash value in order to encode the artifact or unique information allows the artifact or the unique information to be verified on the basis of the certificate and the connection itself, without regard to preexisting information stored at the recipient. Thus, the use of the hash value to bind the single-purpose certificate to a particular purpose is more widely applicable than alternatives.

As a further benefit, use of the single purpose certificate obviates any need for signature revocation services. When a user wishes to revoke a signature, it may simply revoke the certificate.

According to a first aspect, a method of securing one or more defined artifacts, or one or more secure connections, is disclosed. The method includes: generating a single-purpose public key and private key combination; creating a set of hashes of unique information characterizing one or more specific connections or artifacts; sending the single-purpose public key and the set of hashes to a certificate authority; receiving from the certificate authority a single-purpose certificate that includes fields storing an identity of a signer, the set of hashes, metadata identifying the hashed unique information, and the single-purpose public key, wherein the single-purpose certificate is signed with a certificate authority private key; and publishing or sending the single-purpose certificate to a verifier, and, with the single-purpose certificate, at least one of (1) establishing one or more secure connections with the verifier or (2) sending the one or more artifacts to the verifier.

In another implementation according to the first aspect, the signer is a server, the verifier is a client, the method comprises establishing a secure connection between the server and the client under specific conditions, and the set of hashes includes a hash of unique information regarding the secure connection.

In another implementation according to the first aspect, the method comprises publishing or sending an artifact, and the set of hashes includes a hash of the artifact.

In another implementation according to the first aspect, the sending step further comprises sending additional metadata to the certificate authority, said additional metadata including at least one of an identity of the one or more artifacts, an identity of a signing entity, and a time of transmission, and wherein the single purpose certificate comprises fields including said metadata. Optionally, the method further includes signing the hashes in the set of hashes using the single-purpose private key, and sending the signed set of hashes to the certificate authority for inclusion into the single-purpose certificate. Optionally, the method further includes publishing or sending the signed hash to the verifier together with the single-purpose certificate.

In another implementation according to the first aspect, the method includes revoking the single-purpose certificate following the establishing of the one or more secure connections or transmitting of the one or more artifacts.

In another implementation according to the first aspect, the method includes publishing or sending the single-purpose certificate to the verifier multiple times, and, each of said times, publishing or sending at least one of the artifacts or establishing one of the secure connections.

According to a second aspect, a method of generating a single-purpose certificate is disclosed. The method includes: receiving, from a signer, a single-purpose public key and a set of hashes of unique information characterizing one or more specific connections or artifacts; generating a single-purpose certificate with fields including an identity of the signer, the set of hashes, metadata identifying the hashed unique information, and the single-purpose public key; and signing the single-purpose certificate with a certificate authority private key.

In another implementation according to the second aspect, the method further includes verifying an identity of the signer prior to creating the single-purpose certificate. Optionally, the verifying step is performed using one or more of OIDC, API-keys, a user password, or physical identification.

According to another aspect, a method of securely receiving one or more artifacts or establishing one or more secure connections is disclosed. The method includes: accessing a single-purpose certificate issued by a certificate authority, said certificate including fields storing an identity of a signer sending the artifact, a set of hashes of unique information characterizing one or more specific connections or artifacts, metadata identifying the hashed unique information, and a single-purpose public key; wherein the certificate is signed by a private key of the certificate authority; verifying the single purpose certificate using a public key of the certificate authority; accessing at least one artifact or unique information characterizing a secure connection, and generating a hash of the at least one received artifact or of the unique information characterizing the connection; and verifying that the generated hash matches a hash stored in the single-purpose certificate.

Optionally, the single-purpose certificate further includes a signature generated using a single-purpose private key and the hash, and the method further includes verifying the signature with the single-purpose public key.

Optionally, the method further includes verifying that the single-purpose certificate has not been revoked.

Optionally, the method further includes verifying existence of the single-purpose certificate in a certificate transparency log.

According to another aspect, a computer program product is disclosed. The computer program product includes a non-transitory computer-readable medium storing instructions that, when executed by a processor, cause the performance of the following steps: generating a single purpose public key and private key combination; creating a set of hashes of unique information characterizing one or more specific connections or artifacts; sending the single purpose public key, the set of hashes, and metadata identifying the hashed unique information to a certificate authority; receiving from the certificate authority a single-purpose certificate that includes fields storing an identity of a signer, the set of hashes, the metadata identifying the hashed unique information, and the single-purpose public key, wherein the single-purpose certificate is signed with a multi-use certificate authority private key; and with the single-purpose certificate, at least one of (1) establishing one or more secure connections or (2) transmitting the one or more artifacts.

Optionally, the computer program product includes instructions for signing the set of hashes using the single-purpose private key, and sending the set of signed hashes to the certificate authority for inclusion into the single-purpose certificate.

Optionally, the computer program product further includes instructions for sending the set of signed hashes to the receiver together with the single-purpose certificate.

Optionally, the computer program product further includes instructions for revoking the single-purpose certificate following the establishing of the one or more secure connections or transmitting of the one or more artifacts.

According to another aspect, a computer program product is disclosed. The computer program product includes a non-transitory computer-readable medium storing instructions that, when executed by a processor, cause the performance of the following steps: receiving a single-purpose certificate issued by a certificate authority, said certificate including fields storing an identity of a signer, a set of hashes of unique information characterizing one or more specific connections or artifacts, metadata identifying the hashed unique information, and a single-purpose public key; wherein the certificate is signed by a private key of the certificate authority; verifying the single-purpose certificate using a public key of the certificate authority; receiving at least one artifact or unique information characterizing a secure connection, and generating a hash of the at least one received artifact or of the unique information characterizing the connection; and verifying that the generated hash matches a hash stored in the single-purpose certificate.

According to another aspect, a method of generating and revoking a signature is disclosed. The method includes: generating a single-purpose public key and private key combination; creating a set of hashes of unique information characterizing one or more specific connections or artifacts; sending the single-purpose public key and the set of hashes to a certificate authority; receiving from the certificate authority a single-purpose certificate that includes fields storing an identity of a signer, the set of hashes, metadata identifying the hashed unique information, and the single-purpose public key, wherein the single-purpose certificate is signed with a certificate authority private key; signing an artifact with the private key; and revoking the single-purpose certificate.

### BRIEF DESCRIPTION OF THE DRAWINGS

FIG. 1 schematically illustrates the process of creation of a single-purpose certificate, according to embodiments of the present disclosure;

FIG. 2 illustrates steps in a method of sending or publishing an artifact or forming a secure connection with a single-purpose certificate, according to embodiments of the present disclosure;

FIG. 3 illustrates steps in a method of creating a single purpose certificate, according to embodiments of the present disclosure; and

FIG. 4 illustrates steps in a method of accessing an artifact or other information over a secure connection using a single-purpose certificate, according to embodiments of the present disclosure.

### DETAILED DESCRIPTION OF THE INVENTION

The present Application relates to the field of cybersecurity, and more specifically, but not exclusively, to single-purpose certificates including therein hash values related to one or more specific artifacts or one or more specific secure connections.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

As used in the present disclosure, the term “signer” refers to an entity that prepares and sends or publishes artifacts or initiates a secure connection. The term “entity” refers to a machine, such as a software program or computing device, which acts autonomously or under control of a person.

A certificate authority is an entity that verifies identities of users and issues certificates for private key and public key pairs.

The term “verifier” refers to an entity that accesses an artifact or receives information in a transmission, and thus needs to verify the identity of the signer. The term “actor” refers to any entity that may be involved in creation, verification, or transmission with a secure connection, including a user, receiver, certificate authority, certificate revocation service, and certificate transparency log.

As used in the present disclosure, the term “hash” or “hash value” refers to an output of a hash function. A hash function is a function that can be used to map data of arbitrary size to fixed size values. Any hash function that is known or that becomes known may be used for the functions described herein, including MD5, RipeMD160, SHA-1, SHA-256, SHA3-256, or SHA-512. A hash function may be applied to an entire artifact, components of an artifact, or unique information relating to a secure connection. The term “set of hashes” refers to a group of hashes generated on the same input using different hash functions.

As used in the present disclosure, the term “secure transmission” refers to a transmission that takes place through an encrypted link between two parties. A secure transmission is preceded by establishing a secure connection between a server and a client. Examples of protocols that may be used for secure transmission include SSL, IPSEC, and SMIME.

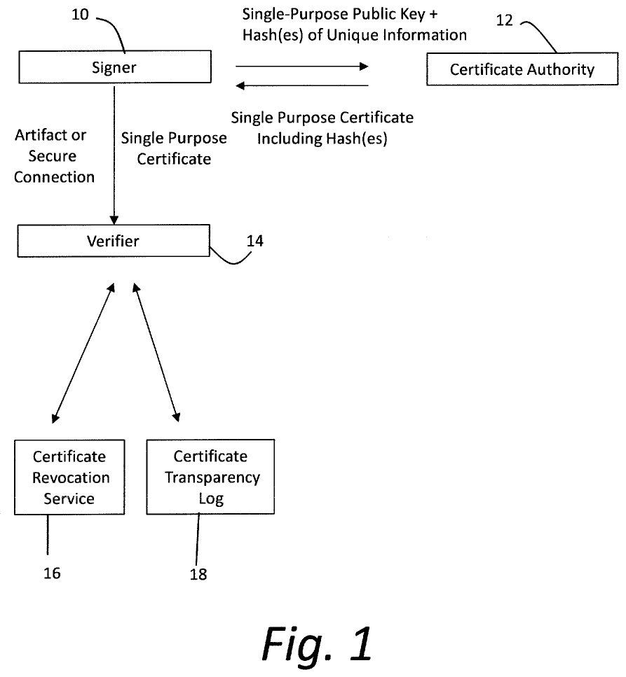

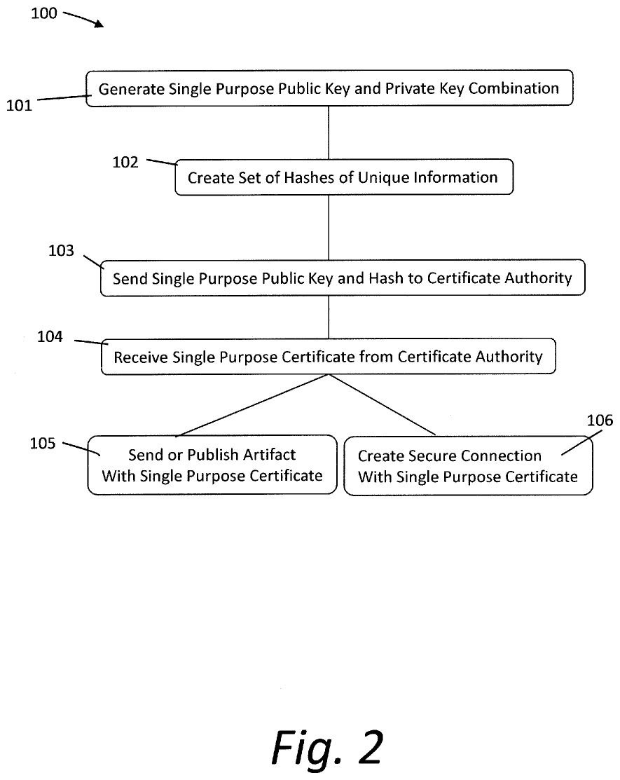

FIG. 1 depicts a flow of information during the creation and use of a single-purpose certificate. FIGS. 2-4 depict the steps taken by each of the signer 10 (method 100), certificate authority 12 (method 200), and verifier 14 (method 300), respectively, during the processes described in connection with FIG. 1. Although the steps of methods 100, 200, and 300 are portrayed based on the actions of each individual actor, it is to be understood that the method steps proceed as part of a single, integrated process. This integrated process may proceed in separate sequential steps, possibly with large delays between the steps.

In the description that follows, each of the actors are portrayed as separate entities. The separate entities may use conventional software, such as a web browser, for performing the various functions described herein.

Optionally, the functions described herein are performed by a computer program. The computer program may be fixed in a non-transitory computer-readable medium storing instructions that, when executed by a processor, cause the performance of the steps described herein. The computer program may include an interface for each of the actors, that enables each of the actors to perform their particular roles, as will be described in further depth herein. There may also be separate computer programs operating on the device of a user and on the device of a receiver, for performing the different functions described herein.

Referring to FIG. 1, signer 10 is any entity that wishes to generate a secure connection or transmit an artifact securely. In a typical example, the signer is a software application. For example, the signer may operate a server with sensitive information (e.g., a bank or brokerage account), and the signer may wish to grant access to that server to a client through a secure connection, such as an SSL connection. In another example, the signer may wish to transmit an artifact, e.g., a file, to a customer.

In a first step, and as shown in step 101 of FIG. 2, the signer 10 generates a single purpose public key and private key pair.

At step 102, the signer generates a set of hashes of unique information characterizing a specific connection or artifact. When the single-purpose certificate is used to protect an artifact, the input for the hash function may be the artifact itself, and/or components of the artifact. The input for the hash function may alternatively be a particular piece of metadata associated with the artifact. When the single-purpose certificate is used to protect a secure connection, the input for the hash function may be a combination of data items associated with the secure connection, for example, a time of the secure connection or an IP address from which the secure connection may originate. In addition, as discussed above, the certificate may include sets of hashes related to multiple specific artifacts or connections, wherein each set of hashes is associated with one of the artifacts or connections. Furthermore, the set of hashes may include multiple hashes generated from the same input or inputs using different hash functions (for example, MD5 and SHA256). Advantageously, this enables the single-purpose certificate to be used even by verifiers that are capable of running only one of a group of hash functions. For simplicity, the remainder of the discussion of methods 100, 200, and 300 addresses only an example in which there is a single hash related to a single artifact or connection.

At step 103, the signer 10 sends the single-purpose public key, metadata identifying the unique information, and the hash of the unique information to the certificate authority 12. The user 10 may optionally send additional verification data to the certificate authority 12, such as the artifact identity, the signing entity identity, or the time. Such verification data may optionally be required by the certificate authority in order to verify the identity of the user, or to confirm that the requested certificate is for a certain artifact type in a certain time, prior to issuing a certificate.

The signer 10 may also sign the hash with the private key. Signing the hash with the private key may save a step in the transmission process. Typically, for transmission with multi-use certificates, a user obtains a certificate, then signs the artifact and sends the signed artifact and the certificate. In the present case, however, since the certificates are single-purpose, the signer 10 may sign the hash (or, alternatively, the artifact itself) and send the signature, instead or in addition to the hash, to the certificate authority 12. The certificate thus serves as both a certificate and a signature of the artifact. When the signer 10 subsequently sends the certificate, it also simultaneously sends a signature of the artifact. In addition, any party that may utilize the certificate would automatically have a signature of the artifact.

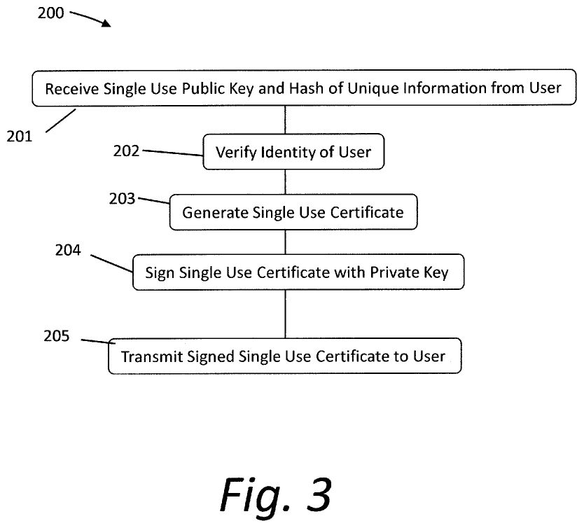

Referring to FIG. 3, in step 201, the certificate authority 12 receives the single-purpose public key along with the hash and the additional verification data, if present. At step 202, the certificate authority 12 verifies the identity of the signer 10. This verification may be performed using conventional techniques, for example, Open ID Connect (OIDC), Application Programming Interface (API) keys, a user password, or physical identification. The verification may also be performed by reference to the additional verification data, as described above.

At step 203, the certificate authority 12 then generates a single-purpose certificate. The single-purpose certificate complies with the X.509 standard, and includes various fields. The fields that are included in the single-purpose certificate include, at least, an identity of the signer the single-purpose public key, metadata identifying the unique information that was hashed, and the hash or set of hashes that was sent by the user 10. The field containing the hash or set of hashes may be an existing field in the certificate or an extension field. For example, the hash or set of hashes may be embedded in the certificate within an extended-name field. The certificate may also include a field identifying the hash function that is used to generate each respective hash.

At step 204, the certificate authority 12 signs the single-purpose certificate with its own multi-use private key, just as it would sign any other certificate. At step 205, the certificate authority then sends the signed certificate back to the signer 10, which receives them at step 104. Alternatively, the certificate authority publishes the signed certificate which the signer then accesses.

Referring now to steps 105 and 106, in the case of sending an artifact, the signer 10 may sign the artifact with its private key. As discussed above, when the certificate itself contains a signature of the hash or of the artifact itself, this step is not necessary. The signer 10 then sends the signed artifact along with the single-purpose certificate to the verifier 14. Alternatively, the signer 10 publishes the artifact, e.g., on a website, thereby making the artifact available for the verifier 14 to access the artifact and download it. In the case of forming a secure connection, the handshake between the client and the server may be formed using the single-purpose certificate instead of a multi-use certificate. For example, the user 10 may respond to a connection request from a client by providing the single-purpose certificate.

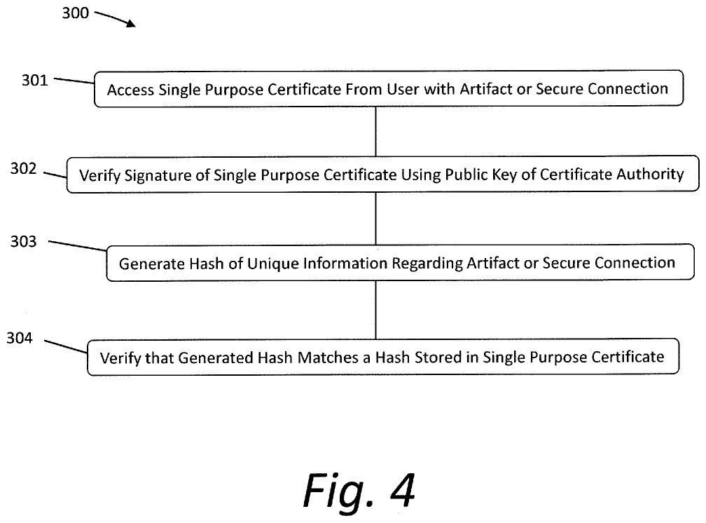

As shown in FIG. 1 and at step 301 in FIG. 4, the verifier 14 accesses the single-purpose certificate. The verifier 14 possesses the public key of the certificate authority, and uses the public key to verify the signature of the certificate authority. Following verification of the certificate, the verifier is able to trust the certificate and thus retrieve and use the single-purpose public key stored in the certificate. At step 302, the verifier 14 further verifies the signature of the artifact, if present, with the single purpose public key stored in the certificate.

At steps 303 and 304, the verifier 14 generates a hash of the artifact or unique information associated with the secure connection, using one of the hash functions and input type defined in the certificate, and evaluates whether the hash of the artifact or unique information is identical to a hash recorded in the certificate. If a signer had attempted to use the single-purpose certificate to publish or transmit a different artifact than the one for which the certificate was created, the hash in the certificate would not match any hash of the transmitted artifact, and the transmission would be rejected. Similarly, if the signer had attempted to initiate a secure connection other than one whose data is referenced in the unique information, the hash would not match, and the connection would be rejected.

Optionally, as part of the verification process, the verifier 14 may verify that the single-purpose certificate has not been revoked before concluding that the certificate is trustworthy. The verifier 14 may do so by using a certificate revocation service 16, similar to the manner for verifying that a multiple-use certificate has not been revoked. The verifier 14 may also use verification products as defined by the signer 10, such as a normalized or pre-processed version of the artifact. In addition, optionally, the verifier 14 may verify the existence of the single purpose certificate in a certificate transparency log 18.

The single-purpose certificates described herein may be intended for single-use or for multiple defined uses. When designed for single use, the certificate may be used to publish or send one or multiple artifacts that were signed at the same time, or during the same transmission. Following performance of the task for which the single-purpose certificate was created, the signer 10 may delete the single-purpose private key. Indeed, the signer 10 may delete the private key after signing the artifact, even before sending anything to certificate authority. Deleting the private key advantageously prevents reuse of the private key, even for transmission of the same artifact. In addition, when the certificate contains the signed artifact hash (i.e., the hash further signed by the single purpose private key), absence of the private key prevents signing of the hash again.

When used for multiple defined uses, the certificates may be used for transmission of multiple defined artifacts or creation of multiple secure connections, at different times. However, each of the uses of the certificate must be for a predefined action, as discussed. Likewise, the single-purpose certificate may be used to separately sign many items that are part of a process leading to a final artifact. The set of hashes included in the certificate could be the hashes of the final artifact, or the hashes of some other singular data item, such as the process ID and the materials used in it. The set of hashes could further comprise hashes of any number of data items that are relevant to the final artifact or its building process. In all instances, as discussed, the inputs used for generating the hashes is identified with metadata in the certificate, to thereby enable generation of hashes to match those that are in the certificate. Using a single-purpose certificate for multiple defined uses, rather than generating a new certificate for every use, may be especially advantageous in circumstances when there are special security requirements relevant to the creation of new private keys. As a result, it is more efficient to allow the signer to save only one certificate, and use that single certificate to bind all the relevant data items.

Advantageously, the verification process utilized here is self-referential. That is, to verify the certificate, there is no need to rely on outside information of any type (aside from the public key of the certificate authority, which is widely available), or a history of prior transmissions between the signer and verifier (such as previously installed software). There is also no need for the verifier to have specially installed software that is used to verify the authenticity of the artifact or transmission. Of course, the methods and certificates described herein are also compatible with the use of outside information to verify the certificate. In addition, the method of verification requires only the performance of a hash function, which is commonly used in cryptography, and thus relatively straightforward to implement.

Another advantage of the above-described system and methods is that, while the private key may only be used a single time, the certificate itself need not be bounded by a particular time. So, as long as the certificate is accompanying an artifact whose hash is encoded in the certificate, the certificate may be validly used.

Still another advantage of the above-described system is that the need for timestamps and certificate revocation services is highly reduced. This is because, even without verification of a timestamp, the certificate is only good for a single, particular use—for example, transmitting a single, specific artifact. Thus, the most damage that an attacker may do with the certificate is to resend the same artifact for which the certificate was initially created. The uses of such an attack are extremely rare.

In addition, the single-purpose certificates described herein are identical in form to standard X.509 certificates, and as a result certain security protections applicable to X.509 certificates are applicable to the single-purpose certificates. For example, if the signer 10 wishes to revoke the certificate, it can utilize existing certificate revocation services.

Furthermore, using the single-purpose certificates described herein, it is possible to revoke a signature of an artifact using the same systems and tools that were created for certificate revocation. Suppose, for example, that after creating a single-purpose certificate, and signing an artifact with the private key associated with the certificate, the signer wishes to revoke that signature. For multi-use certificates, there is no standard way to revoke a signature while retaining the certificate. However, when the signature is performed by a private key associated with a single-purpose certificate, revocation of the signature may be done simply by revoking the certificate. Thus, checking for signature revocation may be effectively performed by checking for certificate revocation, for which one can use existing tools.

It should be noted that the single-purpose certificates described herein, like all certificates, are still theoretically vulnerable to security compromises of the certificate authority 12. For example, an attacker that compromised the certificate authority could implement the steps described above to create single-purpose certificates. These certificates would be used to sign the attacker's artifacts. These artifacts would be attributed to some identity that is confusingly similar to the identity of the user 10. By way of example, if the user has an email address john@bigenterprise.com, the attacker compromising the certificate authority may create signatures corresponding to single-purpose certificates that seem that they are issued from john@bigetnerprise.com. Particularly concerning, the certificates would contain signed hashes of malicious artifacts, and thus the certificates would implicitly vouch for the safety of the artifacts, without an additional check on the signatures.

This security concern may be handled in a few ways. These include: adding another layer of long-term certificates; or using a public certificate-transparency log and requiring verifying subjects to include verifying a valid entry in the certificate-transparency log. Thus, again, the signer 10 and verifier 14 may utilize existing products and services of certificate transparency logs with no modification.

What is claimed is:

1. A method of securing one or more defined artifacts, or one or more secure connections, comprising:
generating a single-purpose public key and private key combination;
creating a set of hashes of unique information characterizing one or more specific connections or artifacts;
sending the single-purpose public key and the set of hashes to a certificate authority;
receiving from the certificate authority a single-purpose certificate that includes fields storing an identity of a signer, the set of hashes, metadata identifying the hashed unique information, and the single-purpose public key, wherein the single-purpose certificate is signed with a certificate authority private key; and
publishing or sending the single-purpose certificate to a verifier, and, with the single-purpose certificate, at least one of (1) establishing one or more secure connections with the verifier or (2) sending the one or more artifacts to the verifier.

2. The method of claim 1, wherein the signer is a server, the verifier is a client, the method comprises establishing a secure connection between the server and the client under specific conditions, and the set of hashes includes a hash of unique information regarding the secure connection.

3. The method of claim 1, wherein the method comprises publishing or sending an artifact, and the set of hashes includes a hash of the artifact.

4. The method of claim 1, wherein the sending step further comprises sending additional metadata to the certificate authority, said additional metadata including at least one of an identity of the one or more artifacts, an identity of a signing entity, and a time of transmission, and wherein the single purpose certificate comprises fields including said metadata.

5. The method of claim 4, further comprising signing the hashes in the set of hashes using the single-purpose private key, and sending the signed set of hashes to the certificate authority for inclusion into the single-purpose certificate.

6. The method of claim 5, further comprising publishing or sending the signed hash to the verifier together with the single-purpose certificate.

7. The method of claim 1, further comprising revoking the single-purpose certificate following the establishing of the one or more secure connections or transmitting of the one or more artifacts.

8. The method of claim 1, further comprising publishing or sending the single-purpose certificate to the verifier multiple times, and, each of said times, publishing or sending at least one of the artifacts or establishing one of the secure connections.

9. A method of generating a single-purpose certificate, comprising:
receiving, from a signer, a single-purpose public key and a set of hashes of unique information characterizing one or more specific connections or artifacts;
generating a single-purpose certificate with fields including an identity of the signer, the set of hashes, metadata identifying the hashed unique information, and the single-purpose public key; and
signing the single-purpose certificate with a certificate authority private key.

10. The method of claim 9, further comprising verifying an identity of the signer prior to creating the single-purpose certificate.

11. The method of claim 10, wherein the verifying step is performed using one or more of OIDC, API-keys, a user password, or physical identification.

12. A method of securely receiving one or more artifacts or establishing one or more secure connections, comprising:
accessing a single-purpose certificate issued by a certificate authority, said certificate including fields storing an identity of a signer sending the artifact, a set of hashes of unique information characterizing one or more specific connections or artifacts, metadata identifying the hashed unique information, and a single-purpose public key; wherein the certificate is signed by a private key of the certificate authority;
verifying the single purpose certificate using a public key of the certificate authority;
accessing at least one artifact or unique information characterizing a secure connection, and generating a hash of the at least one received artifact or of the unique information characterizing the connection; and
verifying that the generated hash matches a hash stored in the single-purpose certificate.

13. The method of claim 12, wherein the single-purpose certificate further includes a signature generated using a single-purpose private key and the hash, and further comprising verifying the signature with the single-purpose public key.

14. The method of claim 12, further comprising verifying that the single-purpose certificate has not been revoked.

15. The method of claim 12, further comprising verifying existence of the single-purpose certificate in a certificate transparency log.

16. A method of generating and revoking a signature, comprising:
generating a single-purpose public key and private key combination;
creating a set of hashes of unique information characterizing one or more specific connections or artifacts;
sending the single-purpose public key and the set of hashes to a certificate authority;
receiving from the certificate authority a single-purpose certificate that includes fields storing an identity of a signer, the set of hashes, metadata identifying the hashed unique information, and the single-purpose public key, wherein the single-purpose certificate is signed with a certificate authority private key;
signing an artifact with the private key; and
revoking the single-purpose certificate.
